(19) United States
(12) Patent Application Publication
(10) Pub. No.: US 2011/0233254 A1
(43) Pub. Date: Sep. 29, 2011

(54) DISPENSER

(75) Inventors: Mats Lundqvist, Falun (SE); Per Mmoller, Falun (SE); Stig Pommer, Hedemora (SE)

(73) Assignee: SCA HYGIENE PRODUCTS AB, Goteborg (SE)

(21) Appl. No.: 13/132,083

(22) PCT Filed: Dec. 1, 2009
(86) PCT No.: PCT/EP2009/066162

§ 371 Date: Jun. 1, 2011

(30) Foreign Application Priority Data
Dec. 1, 2008 (SE) 0802501-7

(51) Int. Cl. A47K 10/36; B65H 35/00; B26D 5/08

(52) U.S. Cl. 225/11; 225/106; 83/614

(57) ABSTRACT

A dispenser for dispensing wiping material includes a housing for holding at least one roll containing a continuous web of wiping material. The dispenser includes a feeding element for controlling the dispensing of the web, wherein the feeding element includes at least a drive roller, a pressure roller and a cutting device. The web is arranged to be fed from a first roll and into the feeding element, and an actuating mechanism operatively connected to the drive roller, wherein the actuating mechanism is actuated by a user applying a force to the actuating mechanism to dispense a predetermined length of wiping material. The actuating mechanism and the drive roller are connected by a lever, wherein the lever is in driving contact with the drive roller and is releasably connected to the actuating mechanism, and that the actuating mechanism and the lever are arranged to disconnect if the actuating mechanism is subjected to a force exceeding a predetermined value.

### TECHNICAL FIELD

The invention relates to the technical field of dispensers for wiping materials with automatic, semi-automatic or manual dispensing which dispensers have applications for paper hand wipes, general-purpose paper wipes, toilet paper and similar wipes. The invention relates to the technical field of wipe dispensers for materials with automatic, semi-automatic or manual dispensing dispensers which have applications for paper hand wipes, general-purpose paper wipes, toilet paper and similar wipes.

### BACKGROUND ART

Dispensing machines for wiping materials are widely used. These machines are often of the type comprising a housing that internally accommodates a drum that receives a cutting device which is articulated relative to the drum and during rotation of the latter; the drum is positioned between support side pieces. The roll of material may be positioned adjacent or resting on the drum, or between support side pieces above in the upper part of the housing. A pressure roller is used to press a web of material from the roll against the drum and allows transport of the web of material towards the back of the machine in order to allow completely safe cutting of the web of material, by above-mentioned cutting device, to a predetermined size. The rolls of material may be coreless or comprise a core that supports the turns of material tightly wound in accordance with the characteristics of the material and market in question. This type of wiping material dispensing machine is generally installed in areas accessible to the public, in areas for company staff or on premises of public sector or private establishments and it is necessary to provide an adequate maintenance organisation to ensure refilling of dispensing machines when the roll of material is exhausted.

Dispensing machines of the above type may be electrically operated automatic or semi-automatic dispensers, where the dispensing of wiping material is initiated by a sensor detecting a user in the proximity of a predetermined portion of the dispenser. Alternatively the dispensing of wiping material is initiated by a user pressing a button or similar to actuate a feeding mechanism. An advantage with this type of automatic or semi-automatic dispensers is that problems relating to paper jamming in the feeding mechanism are reduced, as there is no need for a user to grip and pull the wiping material through a cutting unit and out of the dispenser.

Such electrically operated automatic or semi-automatic dispensers are as a rule provided with some form of manually operated back-up feeding mechanism in case of an interruption in the electrical supply or if the charge level in a battery operated dispenser is too low. Such manually operated back-up feeding mechanism may be in the form of a lever or rotatable crank located at a side wall of the dispenser, or a lever or push-bar located at or across a front wall of the dispenser. Manual operation of the back-up feeding mechanism causes the wiping material to be fed out and cut to length.

A prior art, lever operated sheet dispenser, wherein the wiping material is dispensed through a nip formed by a drive roller and a pressure roller, is described in U.S. Pat. No. 3,459,353. This document describes a manually operated lever and a toothed quadrant member which have a common centre of rotation. The drive roller has a shaft to which is attached a gear that is driven by the quadrant member. Interposed between the gear and the drive roller is a one-way clutch mechanism which allows the rotational motion of the gear to be transmitted to the drive roller for only one direction of rotation of the gear. Since the sheet is dispensed when the lever travels in one direction and is not dispensed when the lever travels in the other direction, it is generally necessary to use a drive roller that has a relatively large diameter in order to dispense a desired length of the material for a single operation of the lever. Since the force applied to the lever must overcome the force applied to the drive roller by the pressure roller, it would be desirable to employ a drive roller with a relatively smaller diameter and to increase the angular rotation of the drive roller during a single operation of the lever in order to dispense the desired length of the wiping material.

A problem with push-bar or lever operated dispensers in general is that the mechanism connecting the lever with the feed roller drive mechanism may be overloaded by excessive forces being applied to the gears in the event the dispenser becomes jammed. These forces are caused by a user attempting to operate the push-bar or lever, whereby the user will simply increase the force on the push-bar or lever when a resistance to movement is encountered. This action may strip gears or otherwise permanently damage other parts of the feeding mechanism and will require replacement of the dispenser.

A solution to this problem is described in EP 0 010 404. This document describes an overload mechanism which prevents excessive force from being applied to a gear segment in the event the dispenser becomes jammed. The assembly that causes rotation of the gear segment includes a lever and an actuator, both mounted for rotation about the same point, and further includes a stop which limits the relative rotation of the lever with respect to the actuator. A spring biases the actuator and the lever at the stop so that under normal conditions the actuator and lever rotate in unison. The actuator provides the contact point whereby the motion of the lever causes rotation of the gear segment. If the dispenser should become jammed or the gear segment should otherwise be prevented from rotating, an excessive force applied to the lever that exceeds the force of the spring biasing the lever and actuator at the stop, will cause the spring to expand thereby allowing the lever to move with respect to the actuator. Thus, the spring absorbs some of the energy when the roller drive means is subjected to high shock forces.

A problem with this solution is that it requires a relatively complicated linkage comprising multiple levers and at least two separate spring means, making assembly complex and increasing the cost of the dispenser. Also, the normal operation of the mechanism is dependent on one of the said spring means, as the lever is not directly connected to the gear segment of the drive mechanism. A repeated application of force to the said spring every time the mechanism is actuated will eventually lead to a permanent extension of the spring. Over time the available displacement of the lever will be insufficient to rotate the gear segment over the angle necessary to allow the desired predetermined length of wiping material to be dispensed.

The object of the invention is therefore to provide an improved solution that solves the above problems and is more reliable in terms of functionality. These objects and others will become apparent from the following description.

### DISCLOSURE OF INVENTION

The above problems are solved by a dispenser according to the appended claims.

The invention relates to dispenser provided with an overload mechanism which prevents excessive force from being applied to a feeding means in the event that the dispenser becomes jammed. The invention may be applied to manual back-up dispensing mechanisms for dispenser operated by manual withdrawal of wiping material or for electrically operated automatic or semi-automatic dispensers where wiping material is dispensed automatically, by use of proximity sensors, by the touch of a button, or similar solutions. The invention may also be applied to mechanical dispensers operated by a lever, push-bar or similar.

According to a preferred embodiment, the invention relates to a dispenser for dispensing wiping material comprising a housing for holding at least one roll containing a continuous web of wiping material. The housing may comprise at least an outer front wall; two outer side walls and said housing comprising a dispensing opening for the wiping material. The dispenser is preferably, but not necessarily, intended for mounting on a wall or similar. The dispenser may further comprise a feeding means for controlling the dispensing of the wiping material, wherein the feeding means may comprises at least a drive roller, a pressure roller and a cutting device. The cutting device may be a stationary tear or cutter bar located adjacent the dispensing opening or a rotary cutter located in and axial slot in a drive roller or a rotary drum means for cutting the web of wiping material to a predetermined length. The pressure roller is arranged to maintain the web in contact with the drive roller during operation of the drive roller. The drive roller can be operated manually by a user withdrawing a leading end of the wiping material. Alternatively, the drive roller may be electrically operated by means of batteries or connected to a mains supply. The web is arranged to be fed from a first roll and into the feeding means for subsequent dispensing out of the dispensing opening.

An actuating mechanism may be operatively connected to the drive roller or rotatable drum, wherein the actuating mechanism is actuated manually by a user applying a force to said actuating mechanism to dispense a predetermined length of wiping material. The actuating means can be used as a manual back-up operating means, in the case of manually or electrically operated dispenser. The actuating means can also be used as a manual main operating means for dispensing the wiping material. The actuating mechanism and the drive roller are connected by a lever, wherein said lever is in driving contact with the drive roller and is releasably connected to the actuating mechanism. The actuating mechanism and the lever are arranged to disconnect if the actuating mechanism is subjected to a force exceeding a predetermined value.

In the subsequent text, the term “actuating mechanism” refers to any suitable means mounted on a pivot for manually actuating a dispenser to dispense a single sheet of wiping material. The actuating mechanism can comprise a transverse lever or push-bar located underneath, at or across a lower portion of a front wall of the dispenser. Alternatively the actuating mechanism may be in the form of a lever or rotatable crank mounted on a single pivot located at or in a side wall of the dispenser.

The actuating mechanism may be mounted on at least one pivot located on one or opposite sides of the dispenser. Similarly, the at least one pivot may be located adjacent one or both ends of the drive roller. The lever may be mounted on a pivot located adjacent one end of the drive roller. The actuating mechanism and the lever are preferably, but not necessarily, mounted side by side and may be pivoted together or separately in parallel planes about a common, single pivot.

The actuating mechanism can be mounted on a pair of pivots located at or in opposite side walls of a feeding mechanism or a cassette containing the feeding mechanism inside the dispenser housing. The actuating mechanism may comprise arms or side portions extending substantially parallel with the opposed side walls, which side portions are joined by a transverse portion extending along or underneath a lower front portion of the dispenser. Manual operation of the actuating mechanism between an initial, or first, position and a fully displaced second position causes the web of wiping material to be fed out. When a predetermined length of wiping material has been fed out, a sheet of wiping material is cut to length.

The lever connecting the actuating mechanism and the drive roller may extend from the pivot along an inner or an outer surface of one of the said side portions of the actuating mechanism. The lever may be provided with a gear segment arranged along a first radius from the first pivot. In the subsequent text, the term “radius” used in the context of gear segments and gear teeth refers to the pitch radius, or the effective contact radius of the respective involute gear teeth. The gear segment may be arranged to cooperate with a gear wheel mounted on a shaft at one end of the drive roller. The radius and the resulting circumferential arc of the gear segment can be chosen in relation to the pitch diameter and the number of teeth of the gear wheel so that a single actuation of the actuating mechanism causes a partial or an entire predetermined length of wiping material to be dispensed. For instance, if the circumferential arc of the gear segment is equal to the circumference of the gear wheel, then one actuation is sufficient to dispense the predetermined length of wiping material. Such an arrangement is preferred for dispensers which are manually actuated only and where a minimum number of actuations are desired. Alternatively, the actuating mechanism may be used as a back-up arrangement for manually or electrically operated dispensers. In such cases, two or more actuations of the actuating mechanism may be used to dispense a predetermined length of wiping material. Consequently the circumferential arc of the gear segment may be less than the circumference of the gear wheel. The number of actuations required to achieve a complete rotation of the gear wheel is directly proportional to the circumferential arc of the gear segment. Such a back-up actuating mechanism may be actuated once or several times, depending on whether a partial or an entire predetermined length of wiping material to be dispensed. For instance, a single actuation generating a partial rotation of the gear wheel may be sufficient to cause a leading end to be presented out of a dispensing opening may be sufficient to allow withdrawal of a sheet of wiping material. The number of actuations can also vary depending on whether or not the actuating mechanism is displaced the entire distance between its initial and end positions. In both these examples, the circumferential arc of the gear segment is equal to the arc through which the handle on the actuating mechanism can be pivoted. A one-way clutch mechanism may be interposed between the gear and the drive roller, allowing the rotational motion of the gear to be transmitted to the drive roller for only one direction of rotation of the gear.

Since the wiping material is dispensed when the actuating mechanism travels in one direction and is not dispensed when the actuating mechanism travels in the other direction, it may be an advantage to use a drive roller in the form of a rotatable drum that has a relatively large diameter in order to dispense a desired length of the material for a single operation of the actuating mechanism. Since the force applied to the actuating mechanism must overcome the force applied to the drive roller by the pressure roller, it would be desirable to employ a gear with a relatively smaller diameter and to increase the angular rotation of the drive roller during a single operation of the actuating mechanism in order to dispense the desired length of the wiping material.

As stated above, the actuating mechanism and the lever are arranged to disconnect if the actuating mechanism is subjected to a force exceeding a predetermined value during the displacement between its first and second positions. The disconnection may be achieved by means of a resilient tongue on the lever that is releasably connected to a projection on the actuating means. The resilient tongue extends away from the main longitudinal direction of the lever, substantially in the same plane as the lever. A portion of the resilient tongue is arranged to cooperate with the projection on the actuating means, which projection extends out of the plane of the actuating means. The resilient tongue may be provided with an angled first contact surface arranged to cooperate with an angled first contact surface on the projection during actuation of the actuating mechanism. The angles of the respective first contact surfaces on the resilient tongue and the projection are selected so that the respective surfaces will remain in contact until a force exceeding a predetermined limit is applied to the actuating mechanism. When this force is exceeded, the resilient tongue will deflect and cause the respective first surfaces to disengage. The actuating mechanism and the lever are then disconnected, allowing the actuating mechanism to be displaced by the user without resistance from the lever and the drive roller in order to prevent damage to the dispenser. The resilient tongue may further be provided with an angled second contact surface arranged to cooperate with an angled second contact surface on the projection during a return movement of the actuating mechanism. In this way, the respective second surfaces will guide the resilient tongue and allow it to be deflected by the second contact surface on the projection when the actuating mechanism is moved back into its initial position. When the actuating mechanism approaches its initial position, the second surfaces are displaced out of contact with each other. The first contact surface on the resilient tongue is then arranged to snap back into contact with or close proximity with the angled first contact surface on the projection. The actuating mechanism and the lever are then re-connected for simultaneous displacement during a subsequent actuation of the actuating mechanism.

Alternatively, the disconnection may be achieved by means of a resilient tongue on the lever being releasably connected to a recess in the actuating means, which recess extends away from the plane of the lever. The resilient tongue may be provided with an angled first contact surface arranged to extend towards the plane of the actuating mechanism and into the recess and cooperate with an angled first contact surface in said recess during actuation of the actuating mechanism. As described above, the angles of the respective first contact surfaces on the resilient tongue and the recess are selected so that the respective surfaces will remain in contact until a force exceeding a predetermined limit is applied to the actuating mechanism. The actuating mechanism and the lever are then disconnected, allowing the actuating mechanism to be displaced by the user without resistance from the lever and the drive roller. Similarly, the resilient tongue may be provided with an angled second contact surface arranged to cooperate with an angled second contact surface adjacent the recess, or with a side surface of the adjacent side portion of the actuating mechanism, during a return movement of the actuating mechanism. This enables the respective second surface to guide the resilient tongue and allows the lever to resume operative contact with the actuating mechanism when the actuating mechanism is moved back into its initial position. As the second surfaces are displaced out of contact with each other, the first surface on the resilient tongue will snap into contact with the angled first contact surface in the recess. The actuating mechanism and the lever are then re-connected to provide simultaneous displacement during a subsequent actuation of the actuating mechanism.

The above examples are related to dispensers comprising a single roll of material, but the general principle can also be applied to dispensers comprising more than one roll. A typical example of the latter type of dispenser may comprise a spare or stub roll, that may be partially exhausted, and a main, service or supply roll, that replaces the spare/stub roll once it is exhausted. The replacement may be automatic or performed manually.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 schematically illustrates a dispenser according to the invention;

FIG. 2 shows a cassette with a feeding means as used in the dispenser of FIG. 1;

FIG. 3 shows a side view of the cassette in FIG. 2;

FIG. 3A shows an enlarged view of a portion of the cassette in FIG. 3;

FIGS. 4-8 schematically illustrates the manual operation of an actuating mechanism according to the invention;

### EMBODIMENTS OF THE INVENTION

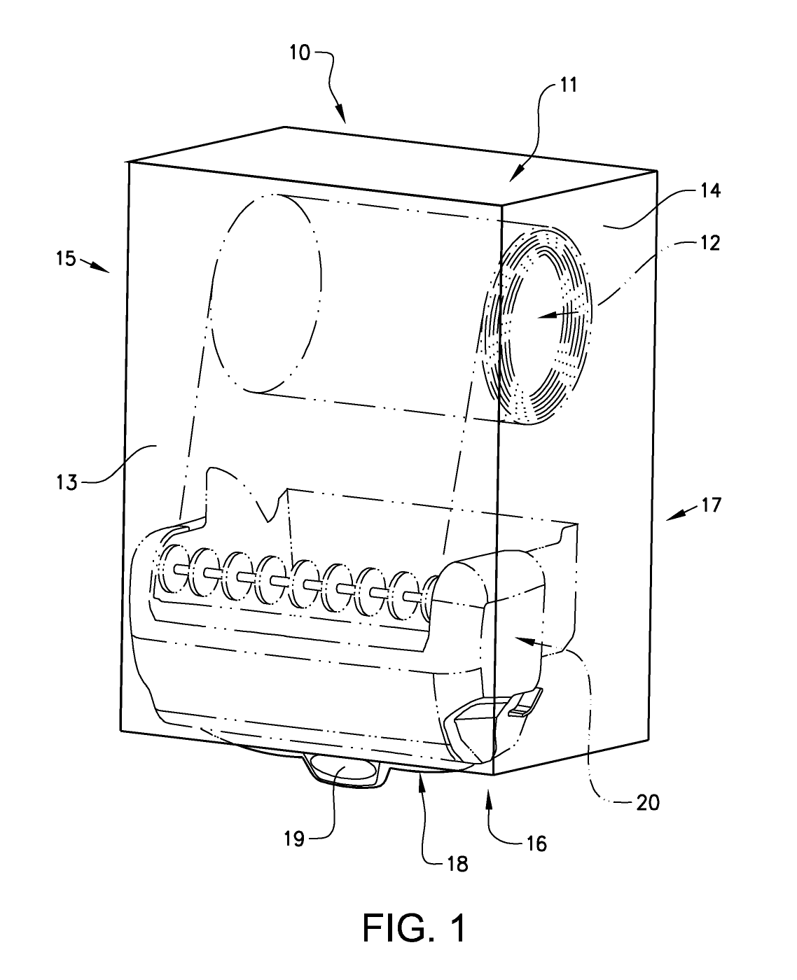

FIG. 1 schematically illustrates a dispenser 10 for dispensing wiping material comprising a first housing 11 for holding a roll 12 containing a continuous web of wiping material. The first housing 11 comprises an outer front wall 13 two outer side walls 14, 15 and a dispensing opening 16 for the web is provided adjacent a lower portion of said outer front wall 13. In this example, the entire visible portion of the first housing 11 forms a cover that can be opened by pivoting the cover outwards and downwards to allow access to the interior of the dispenser during re-filling or servicing thereof. The first housing 11 is attached to a chassis 17 intended for mounting on a wall. The dispenser comprises a feeding means for controlling the dispensing of the web from the roll 12, which feeding means will be described in further detail below. A manually actuated actuating mechanism 18 is operatively connected to the feeding means, wherein the actuating mechanism 18 is actuated by a user applying a force to a handle 19 to dispense a predetermined length of wiping material through the dispensing opening. During normal operation the handle will be located behind a leading edge of the wiping material that is presented to the user below the dispensing opening 16. The handle 19 extends out of a lower portion of the housing 11 adjacent and behind the dispensing opening 16 only to be presented to the user when a misfeed or similar malfunction has occurred. The first housing 11 holds an inner, second housing. In this example the inner, second housing is a cassette 20 (indicated in dashed lines) which is attached to the chassis 17. The cassette 20 comprises two side walls and a rear wall enclosing the feeding means on three sides. The current example, relates to a manually operated dispenser where a user can grasp and withdraw consecutive sheets of wiping material, which are cut to length by a cutting means as each sheet leaves the dispenser. The actuating mechanism 18 is operated by means of the handle 19 and is used as a back-up for a manually operated dispenser when the leading end of the wiping material is not presented to the user below the dispensing opening.

In an alternative example, the dispenser is an electrically operated, sensor actuated dispenser, whereby the actuating mechanism is used as a manually operated back-up if the electrical supply is interrupted or if the sensor used for initiating dispensing has a malfunction. The electrical operation of the dispenser is not part of the invention and will not be described here.

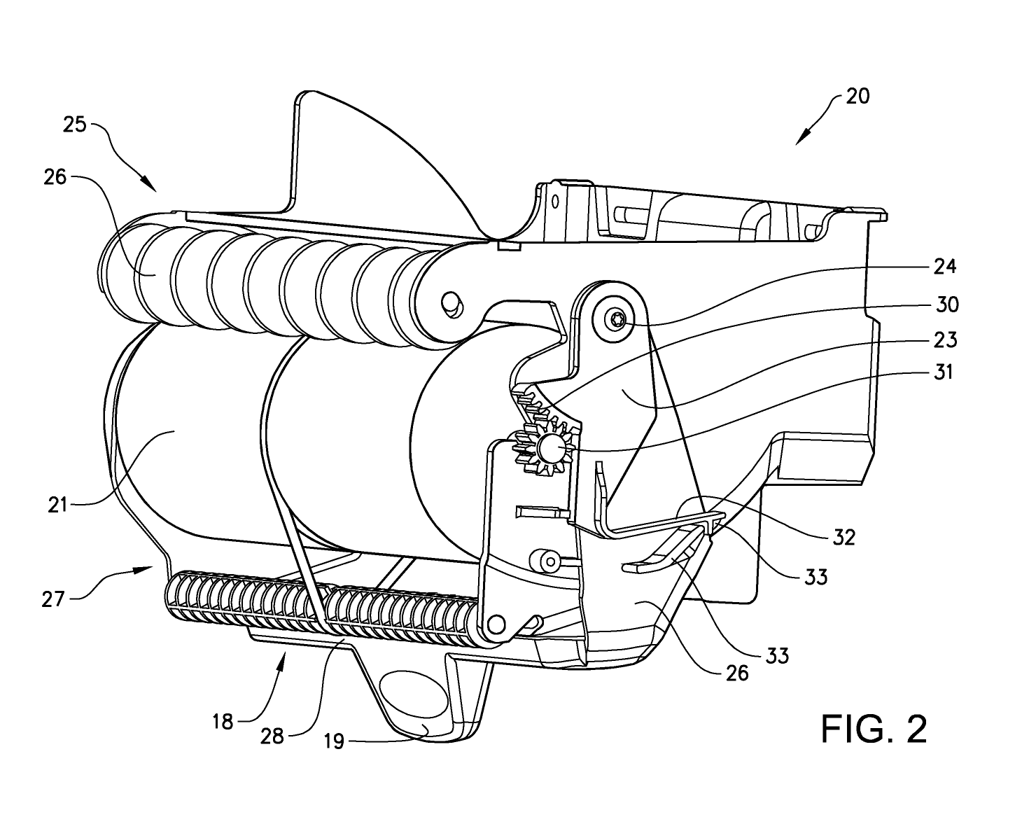

FIG. 2 shows a cassette with a feeding means as used in the dispenser of FIG. 1. The feeding means comprises cassette 20 in which is mounted a drive roller in the form of a rotatable drum 21 that is provided with a cutting means (not shown) for cutting the web to a predetermined length. In this example, the cutting means is a rotary cutter located in an axial slot in the rotatable drum 21. An example of a rotary cutter of this type is described in the published international application WO 2005/096903, which is hereby incorporated by reference. A pressure roller 22 is arranged to maintain the web in contact with the rotatable drum 21 during feeding of the web. Each end of the rotatable drum 21 and the pressure roller 22 comprises an axle rotatably mounted in recesses in the cassette 20. Examples of suitable feeding mechanisms of this type are described in the published international applications WO 97/024970 and WO 2008/107601, which are hereby incorporated by reference.

The actuating mechanism 18 is operatively connected to the rotatable drum 21, wherein the actuating mechanism 18 is actuated by a user applying a force to said actuating mechanism 18 to dispense a predetermined length of wiping material.

The actuating mechanism 18 and the rotatable drum 21 are connected by a lever 23, which lever is in direct driving contact with the rotatable drum 21 and is releasably connected to the actuating mechanism 18. The actuating mechanism 18 and the lever 23 are arranged to disconnect if the actuating mechanism is subjected to a force exceeding a predetermined value.

The actuating mechanism 18 is mounted between a first and a second pivot 24, 25, respectively, located on opposite sides of the cassette 20. The pivots 24, 25 are located adjacent an axle at each respective end of the rotatable drum 21 in opposite side walls of the cassette 20. The lever 23 is mounted on a second pivot 24 located adjacent one end of the rotatable drum 21. In the example shown in FIG. 2 the actuating mechanism 18 and the lever 23 are mounted on a common pivot, corresponding to the first 24 in one side wall of the cassette 20. The actuating mechanism 18 comprises side portions 26, 27 arranged to extend from the respective first and second pivots 24, 25 downwards along the side walls of the chassis and a transverse portion 28 extending below the lower surface of the cassette 20 to join the side portions 26, 27. The handle 19 is part of the transverse portion 28 and extends downwards from the transverse portion 28. The handle 19 is arranged to extend below the lower edge of the dispenser housing 11, as indicated in FIG. 1 and is intended to be pushed by a user to dispense a predetermined length of wiping material.

Alternatively, the actuating mechanism may be in the form of a lever or rotatable crank mounted on a single pivot located at or in a side wall of the dispenser.

In the case of a misfeed or if a previous user has withdrawn a sheet of wiping material to quickly, the leading end of the subsequent sheet to be cut may not be properly presented to the user out of the dispensing opening. When the leading end of the first sheet is not present in front of the handle 19, this indicates to the user that manual actuation is required for dispensing a sheet. Manual operation comprising one or more actuations of the actuating mechanism 18 between an initial first position and a fully displaced end or second position causes the leading end of the wiping material to be fed out and displayed below the dispensing opening. The leading end of the wiping material can then be withdrawn and a sheet cut to length by the rotary cutter. During manual back-up operation, the lever 23 is intended to be displaceable with the actuating mechanism 18 between an initial first position and a fully displaced end or second position.

The lever 23 connecting the actuating mechanism 18 and the rotatable drum 21 is provided with a gear segment 30 arranged along a first radius from the first pivot 24. The gear segment 30 is arranged to cooperate with a gear wheel 31 mounted on a shaft at one end of the rotatable drum 21. The radius and the resulting circumferential arc of the gear segment 30 can be chosen in relation to the diameter and the number of teeth of the gear wheel 31 so that a single actuation of the actuating mechanism 18 is sufficient to dispense a desired length of wiping material. Such an arrangement is preferred for dispensers which are manually actuated only and where a minimum number of actuations are desired. However, the current example relates to a back-up arrangement for an electrically operated dispenser. In such cases, two or more actuations of the actuating mechanism 18 can be allowed to dispense a desired length of wiping material. One reason for this is that the dispenser may have a limited available space for the back-up mechanism and the associated manual actuating handle. In both the above examples, the circumferential arc of the gear segment is substantially equal to or larger than the arc through which the handle can be displaced. A one-way clutch mechanism (not shown) is interposed between the gear wheel 31 and the rotatable drum 21, allowing the rotational motion of the gear wheel 31 to be transmitted to the rotatable drum 21 in one direction of rotation of the gear wheel 31. In the opposite direction the gear wheel 31 will be rotated by the lever 23 returning to its initial position without any rotational movement being transmitted to the rotatable drum 21.

The wiping material is only dispensed when the actuating mechanism 18 travels in one direction from an initial to an end position and is not dispensed when the actuating mechanism 18 travels in the opposite direction from the end position to the initial position. It is an advantage to use a rotatable drum 21 that has a diameter with a circumference corresponding to the desired length of the wiping material in order to dispense the said length of wiping material a single operation of the actuating mechanism 18. Since the force applied to the actuating mechanism 18 must overcome the force applied to the rotatable drum by the pressure roller 22, it is desirable to employ a gear wheel 31 with a relatively small diameter to increase the angular rotation of the rotatable drum 21 during each operation of the actuating mechanism 18.

In order to dispense a length of the wiping material corresponding to a complete turn of the rotatable drum 21 the handle 19 as illustrated in this example would have to be actuated three times. However, in case of a misfeed or a mistimed cut, whereby the leading end of the wiping material is not presented to the user, a single actuation corresponding to a third of a turn of the rotatable drum 21 can be sufficient to feed the leading end of the wiping material out of the dispenser.

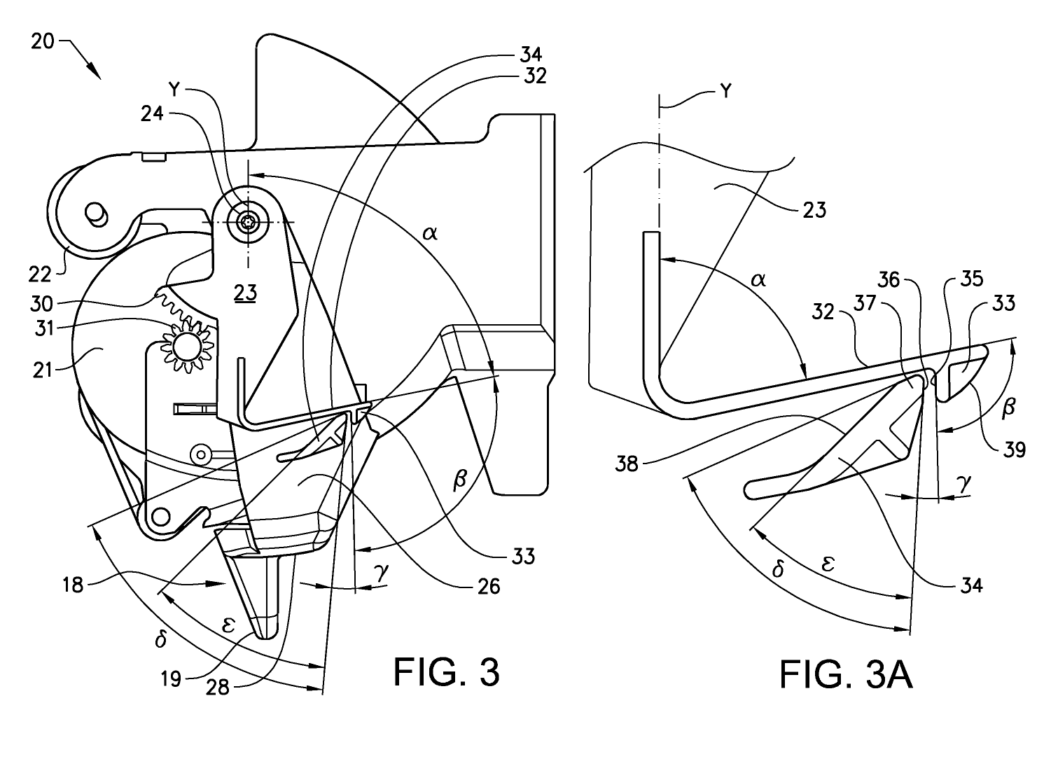

The actuating mechanism 18 and the lever 23 are arranged to disconnect if the actuating mechanism 18 is subjected to a force exceeding a predetermined value during the displacement between the first and second positions of the actuating mechanism 18. The disconnection is achieved by means of a resilient tongue 32 on the lever 23, which resilient tongue 32 extends at a first predetermined angle relative to the main longitudinal direction of the lever 23. A leg of an L-shaped end portion 33 of the resilient tongue 32 is releasably connected to a projection 34 on a first side portion 26 of the actuating means 18. The relative relationship between the radius of the gear segment 30 and the distance between the first pivot 24 and the handle 19 acted on by a user is selected to give a sufficient resultant force to rotate the rotatable drum 21. In the current example, the radius of the gear segment is approximately a third of the distance between the first pivot 24 and the handle 19. The relative relationship between the radius of the gear segment 30 and the distance between the first pivot 24 and the L-shaped end portion 33 at the end of the resilient tongue 32 is determined by the predetermined value of the force required to disconnect the actuating mechanism 18 from the lever 23. In the current example, the radius of the gear segment is approximately half the distance between the first pivot 24 and the L-shaped end portion 33. A detailed example of the cooperating portions of the resilient tongue 32 and the projection 34 on the first side portion 26 will be described in connection with FIG. 3 below.

FIG. 3 shows a side view of the cassette 20 in FIG. 2 with the actuating mechanism 18 and the lever 23 at rest in their initial positions. In the subsequent text, angles are given with reference from a datum line located in a vertical plane Y through the axis of the first pivot 24. Any angles described in this embodiment are given as non-limiting examples only. An enlarged view of the cooperating portions of the projection 34 on the actuating mechanism 18 and the resilient tongue on the lever 23 is shown in FIG. 3A.

With reference to FIGS. 3 and 3A, the resilient tongue 32 extends in a plane located at a first angle α from the vertical datum line, measured in a clockwise direction. The angle α can be selected in the range 70°-90°, preferably 75°-85°. The current example of FIGS. 3 and 3A uses a first angle α of 78°. Continuing in the clockwise direction, the L-shaped portion 33 on the resilient tongue 32 is provided with a first contact surface 35 extending from a lower surface of the resilient tongue 32. The first contact surface 35 extends at a second angle β from the plane of the resilient tongue 32. The second angle β can be selected in the range 90°-110°, preferably 95°-105°. The current example uses a second angle β of 100°. The L-shaped end portion 33 on the resilient tongue 32 is provided with an angled first contact surface 35 arranged to cooperate with an angled first contact surface 36 on the projection 34 on the lever 23 during actuation of the actuating mechanism 18. The first contact surface 36 on the projection 34 may be parallel to or be arranged at a third angle γ away from the first contact surface 35 on the L-shaped end portion 33. The third angle γ can be selected in the range 0°-5°, preferably 1°-3°. The current example uses a third angle γ of 2°. The third angle γ is measured when the resilient tongue 32 is in its initial position, while the L-shaped portion 33 is out of contact with the projection 34 on the lever 23. During normal actuation of the actuating mechanism 18, the loading on the resilient tongue 32 will cause an elastic deformation of the resilient tongue 32. This deformation causes the third angle γ to decrease, in the current example from 2° to 1°. During normal feeding actuation of the actuating mechanism 18 the inner corner of the L-shaped end portion 33 is arranged to cooperate with a front portion or nose 37 of the projection 34.

Measured from the plane of the first contact surface 36 on the projection 34, the nose encloses a fourth angle δ that can be selected in the range 60°-80°, preferably 65°-75°. The current example uses a fourth angle δ of 67°. The enclosed angle δ of the nose 37 should be less than the complimentary angle for the second angle β between the first contact surface 35 on the L-shaped end portion 33 and the plane of the resilient tongue 32. The rear side of the projection 34 is provided with a second contact surface 38, which faces away from the first contact surface 35 on the L-shaped end portion 33. The second contact surface 38 extends at a fifth angle ε from the plane of the first contact surface 36 on the projection 34, which fifth angle ε is less than the fourth angle δ. The fifth angle ε can be selected in the range 40°-60°, preferably 45°-55°. The current example uses a fifth angle ε of 48°. This second contact surface 38 on the projection 34 is arranged to cooperate with a corresponding second contact surface 39 arranged on the rear side of the L-shaped end portion 33

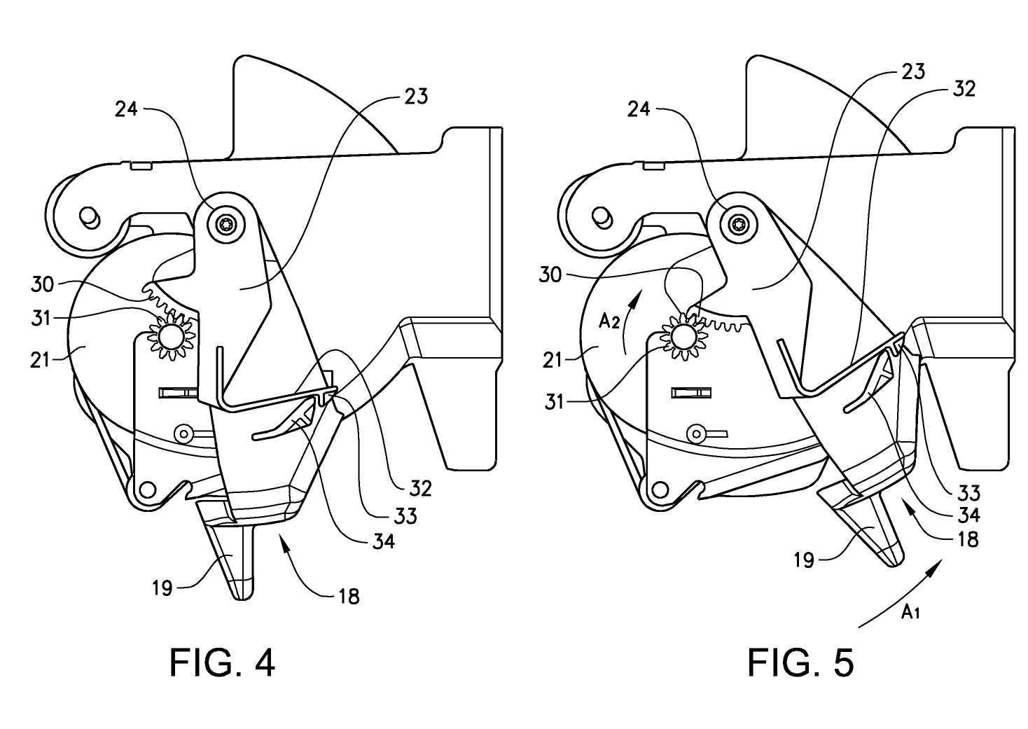

The operation of the manual feeding mechanism will be described with reference to FIGS. 4-8. FIG. 4 shows a side view of the cassette 20 with the actuating mechanism 18 and the lever 23 at rest in their initial positions. The actuating mechanism 18 is held in this position by a first spring load that causes the actuating mechanism 18 to rest against a stop (not shown). Similarly, the lever 23 is held in its initial position by a second spring load that causes the lever 23 to rest against a stop (not shown), where the gear segment 30 is in the correct position for rotating the gear wheel 31 on the rotatable drum 21.

In its initial position the L-shaped portion 33 on the lever 23 is out of contact with the projection 34 on the actuating mechanism 18. When it is desired to dispense a sheet of wiping material using manual operation, the user will apply a force onto the handle 19 to pivot the handle in the direction of the arrow A₁. The handle is then pivoted from its initial position to its end position, as shown in FIG. 5. The first contact surface 35 on the L-shaped end portion 33 will contact the first contact surface 36 on the nose 37 of the projection 34, whereby actuation of the handle 19 will pivot the lever 23 and its associated gear segment 30 to rotate the gear wheel 31 at the end of the rotatable drum 21 in the direction of the arrow A₂. As schematically illustrated in FIG. 5, the circumferential arc of the gear segment 30 on the lever 23 is equal to the arc through which the handle 19 can be displaced. In this case, three actuations of the actuating mechanism 18 are performed in succession to achieve a complete turn of the rotatable drum 21 and dispense a desired length of wiping material.

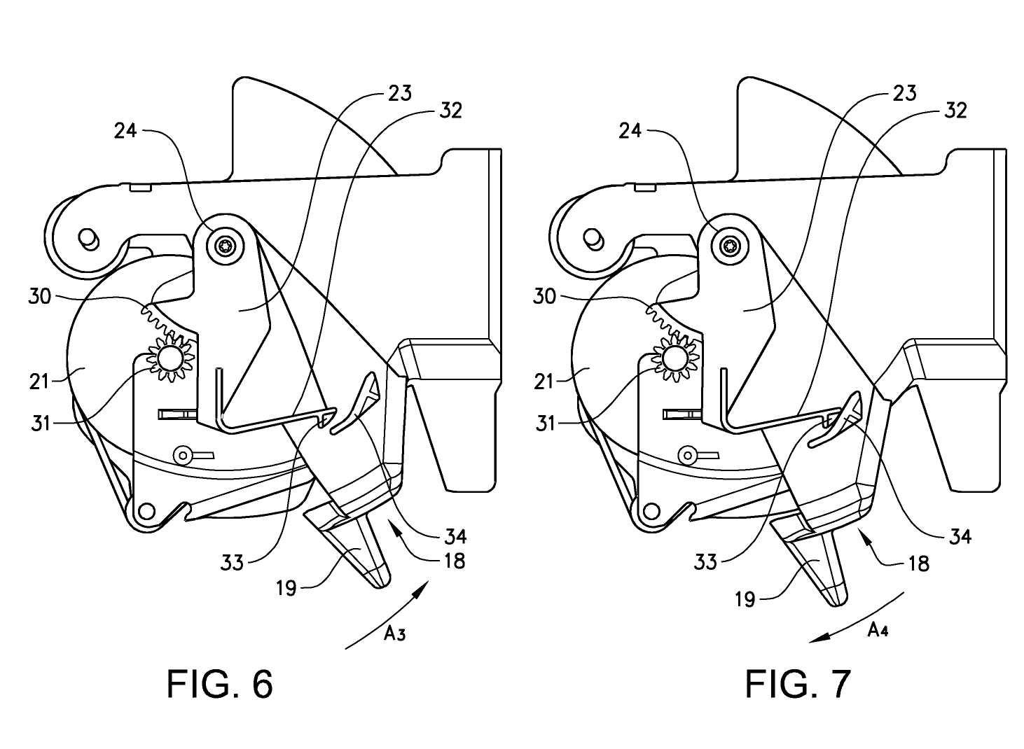

In case of a paper jam occurring in the feeding mechanism, the L-shaped end portion 33 on the resilient arm 32 is arranged to release from the projection 34 on the lever 23. The angles of the respective first contact surfaces 35, 36 on the L-shaped end portion 33 of the resilient tongue 32 and the projection 34, respectively, are selected so that the respective surfaces will remain in contact until a force exceeding a predetermined limit is applied to the handle 19 of the actuating mechanism 18. When this force is exceeded, the resilient tongue 32 will deflect and cause the first surface 35 on the L-shaped end portion 33 and the first surface 36 on the projection 34 to disengage. The actuating mechanism 18 and the lever 23 are then disconnected, allowing the actuating mechanism 18 to be displaced by the user without resistance from the lever 23 and the rotatable drum in order to prevent damage to the dispenser. As indicated in FIG. 6, the lever 23 will stop in the position where the resistance to displacement exceeded the predetermined limit, while the actuating mechanism 18 can be pivoted to its end position in the direction of the arrow A₃. When the lever 23 has been released from the actuating mechanism 18 it will return to its initial portion by the second spring load.

Once the actuating mechanism 18 has been pivoted to its end position the user will realize that a malfunction has occurred, as no wiping material is dispensed, and will release the handle 19. The actuating mechanism is then returned towards its initial position by the first spring load.

During the return movement of the actuating mechanism 18 the angled second contact surface 39 on the rear side of the L-shaped end portion 33 will come into contact with the angled second contact surface 38 on the projection 34, as indicated in FIG. 7. In this way, the respective second surfaces 38, 39 will guide the resilient tongue 32 and allow it to deflect as the actuating mechanism 18 is moved back towards its initial position, as indicated by the arrow A₄. Immediately before the actuating mechanism reaches its initial position the first contact surface 35 on the L-shaped end portion 33 of the resilient tongue 32 is arranged to snap back over the nose 37 and the first contact surface 36 on the projection 34 (see FIG. 3A). When the actuating mechanism 18 reaches its initial position, the respective first surfaces 35, 36 have been displaced out of contact with each other. The actuating mechanism 18 and the lever 23 can then be re-connected for simultaneous displacement during a subsequent actuation of the handle 19 of the actuating mechanism 18.

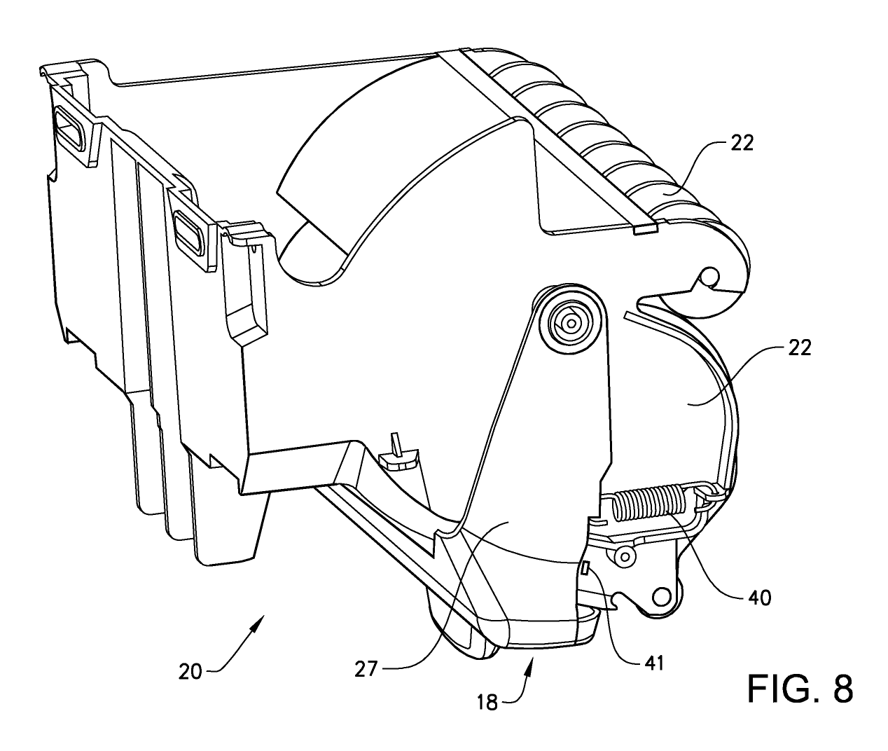

FIG. 8 illustrates a perspective view of the opposite side of the dispenser as shown in FIGS. 4-7. As can be seen from FIG. 8, a second side portion 27 of the actuating means 18 is connected to a side wall of the cassette 20 by a coil spring 40. The coil spring 40 is arranged to hold the actuating means 18 in its initial position, defined by a stop 41. During actuation, the actuating mechanism 18 is displaced away from the stop against the spring load applied by the coils spring 40. Upon release of the actuating mechanism 18, the coil spring 40 will return the actuating mechanism 18 to its initial position.

The invention is not limited to the embodiments described above. In particular, the above examples relates to an actuating mechanism used as a back-up for a manually operated dispensing arrangement where the user grasps and withdraws consecutive sheets of wiping material. The invention may be applied to manually actuated dispensers using only the actuating mechanism for dispensing the wiping material. However, within the scope of the invention, the actuating mechanism may also be applied to an electrically operated dispenser, wherein the described manually actuated actuating mechanism would provide a back-up actuating means in the case of a power failure or of the battery level is low.

1-11. (canceled)

12. A dispenser for dispensing wiping material comprising
a housing for holding at least one roll containing a continuous web of wiping material; said housing comprising an outer front wall, two outer side walls and a dispensing opening for the web,
a feeding unit for controlling the dispensing of the web; said feeding unit comprising at least a drive roller, a pressure roller and a cutting device;
said web being arranged to be fed from a first roll and into the feeding unit; and
an actuating mechanism operatively connected to the drive roller; said actuating mechanism being actuated by a user applying a force to said actuating mechanism to displace the actuating mechanism from a first position to a second position in order to dispense a predetermined length of wiping material;
wherein the actuating mechanism and the drive roller are connected by a lever, which is in driving contact with the drive roller and is releasably connected to the actuating mechanism; a resilient tongue on the lever is releasably connected to a projection or a recess on the actuating mechanism; the actuating mechanism and the lever are arranged to disconnect if the actuating mechanism is subjected to a force exceeding a predetermined value, and the actuating mechanism is displaceable towards the second position without resistance from the lever and the drive roller.

13. The dispenser according to claim 12, wherein the actuating mechanism is mounted on at least one pivot.

14. The dispenser according to claim 12, wherein the lever is mounted on a pivot.

15. The dispenser according to claim 12, wherein the actuating mechanism and the lever are mounted on a common pivot.

16. The dispenser according to claim 12, wherein the resilient tongue is provided with an angled first contact surface arranged to cooperate with an angled first contact surface on the projection during actuation of the actuating mechanism.

17. The dispenser according to claim 16, wherein the resilient tongue is provided with an angled second contact surface arranged to cooperate with an angled second contact surface on the projection during a return movement of the actuating mechanism.

18. The dispenser according to claim 12, wherein the resilient tongue is provided with an angled first contact surface arranged to cooperate with an angled first contact surface in the recess during actuation of the actuating mechanism.

19. The dispenser according to claim 18, wherein the resilient tongue is provided with an angled second contact surface arranged to cooperate with an angled second contact surface in the recess during a return movement of the actuating mechanism.

20. The dispenser according to claim 16, wherein the lever is provided with a gear segment in driving contact with a gear wheel at one end of the drive roller.

21. The dispenser according to claim 13, wherein the lever is mounted on a pivot.

22. The dispenser according to claim 13, wherein the actuating mechanism and the lever are mounted on a common pivot.

23. The dispenser according to claim 14, wherein the actuating mechanism and the lever are mounted on a common pivot.

24. The dispenser according to claim 17, wherein the lever is provided with a gear segment in driving contact with a gear wheel at one end of the drive roller.

25. The dispenser according to claim 18, wherein the lever is provided with a gear segment in driving contact with a gear wheel at one end of the drive roller.

26. The dispenser according to claim 19, wherein the lever is provided with a gear segment in driving contact with a gear wheel at one end of the drive roller.
